(19) United States
(12) Patent Application Publication
(10) Pub. No.: US 2009/0273729 A1
(43) Pub. Date: Nov. 5, 2009

(54) Polarizing plate, manufacturing method thereof and display device using the same

(75) Inventors: Pei-Chuan Yeh, Hsin-Chu (TW); Yen-Wei Lee, Hsin-Chu (TW); Wen-Chin Lo, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/289,115

(22) Filed: Oct. 21, 2008

(30) Foreign Application Priority Data
May 2, 2008 (TW) 97116337

(51) Int. Cl. G02F 1/13357; G02B 5/30; B32B 17/00

(52) U.S. Cl. 349/64; 359/485; 156/99

(57) ABSTRACT

A polarizing plate, a manufacturing method thereof and a display device using the same are provided. The polarizing plate comprises a brightness-enhancement film, a diffuser layer and a polarizing film. The diffuser layer is formed on one surface of the brightness-enhancement film, and the polarizing film is disposed on another surface of the brightness-enhancement film.

This application claims the benefit of Taiwan application Serial No. 097116337, filed May 2, 2008, the subject matter of which is incorporated herein by reference.

### BACKGROUND OF THE INVENTION

1. Field of the Invention

The invention relates in general to a display device having a polarizing plate, and more particularly to a polarizing plate, a manufacturing method thereof and a display device using the same.

2. Description of the Related Art

Flat display devices have been widely used in various electronic products. Liquid crystal display devices also become more popular, due to the advantages of low power consumption, low driving voltage and simple manufacturing process. Generally, the liquid crystal display device includes a display panel and a backlight module. In order to perform an image on the screen of the liquid crystal display device, the backlight module provides a light to the display panel.

Typically, the backlight module has a light-emitting source and several optical films. The light-emitting source is used for providing a light, and the optical films are used for improving the optical properties of the light. The types of the optical film include prism film, light guide film, reflective film, brightness-enhancement film and diffusion film. Those optical films are adapted for reflecting, guiding, focusing and diffusing the light. However, as the quantity of the optical film increases, the assembly of the optical films turns more and more difficult, and the assembly time of the backlight module also increases. Moreover, the thickness of an optical film at least amounts to hundreds of μm, and as the quantity of the optical film increases, the thickness and weight of the display device also grows. On the other hand, if the quantity of the optical film is insufficient, the optical properties of the light will be deteriorated. For example, the brightness and contrast of the light is deteriorated, hence affecting the display quality of the display device. Thus, how to reduce the thickness of the display device without affecting the display quality of the display device has become one of the important topics in the research and development of the display device.

### SUMMARY OF THE INVENTION

The invention is directed to a polarizing plate, a manufacturing method thereof and a display device using the same. A polarizing film, a brightness-enhancement film and a diffuser layer are integrated into a single polarizing plate to reduce the thickness of the display device and increase the optical properties of the display device.

According to a first aspect of the present invention, a polarizing plate used in a display device is provided. The polarizing plate comprises a brightness-enhancement film, a diffuser layer and a polarizing film. The diffuser layer is formed on one surface of the brightness-enhancement film, and the polarizing film is disposed on another surface of the brightness-enhancement film.

According to a second aspect of the present invention, a display device is provided. The display device comprises the polarizing plate disclosed above, a display panel and a backlight module. The display panel comprises a first substrate, a second substrate, and a liquid crystal layer, wherein the liquid crystal layer is contained between the first substrate and the second substrate. The backlight module is disposed on one side of the display panel, wherein the polarizing plate is disposed between the backlight module and the display panel.

According to a third aspect of the present invention, a manufacturing method of polarizing plate is provided. The method comprises the following steps. A brightness-enhancement film is provided. A diffuser layer is formed on the brightness-enhancement film. A polarizing film is provided. The polarizing film and the brightness-enhancement film having a diffuser layer are coupled to form a single plate.

The invention will become apparent from the following detailed description of the preferred but non-limiting embodiments. The following description is made with reference to the accompanying drawings.

### BRIEF DESCRIPTION OF THE DRAWINGS

FIG. 1 shows a display device according to a preferred embodiment of the invention;

FIG. 2 shows a polarizing plate according to a preferred embodiment of the invention;

FIGS. 3A and 3B respectively show the polarizing plates according to a first control experimental group and a first experimental group in Experiment 1 of the invention;

FIGS. 4A and 4B respectively show the polarizing plates according to a second control experimental group and a second experimental group in Experiment 1 of the invention; and

FIG. 5A˜FIG. 5C show a method of manufacturing the polarizing plate of FIG. 2.

### DETAILED DESCRIPTION OF THE INVENTION

A polarizing plate, a manufacturing method thereof and a display device using the same are disclosed in the invention. The invention mainly disposes a polarizing plate on a substrate of a display device: The polarizing plate possesses the functions of brightness-enhancement and diffusion so that the quantities of the diffusion film and the brightness-enhancement film used in the backlight module are reduced, and the thickness of the backlight module is also reduced. As the backlight module has become thinner, the overall thickness of the display device is reduced after the assembly of the backlight module and the display panel. Furthermore, compared with the conventional display device, the polarizing plate having the functions of brightness-enhancement and diffusion disclosed in the invention has higher brightness and contrast, hence improving the optical properties of the display device.

A preferred embodiment is disclosed below for elaborating the invention. However, the specification and the drawings are to be regarded as an illustrative sense rather than a restrictive sense. Additionally, the drawings used for illustrating the embodiments and applications of the present invention only show the major characteristic parts in order to avoid obscuring the present invention.

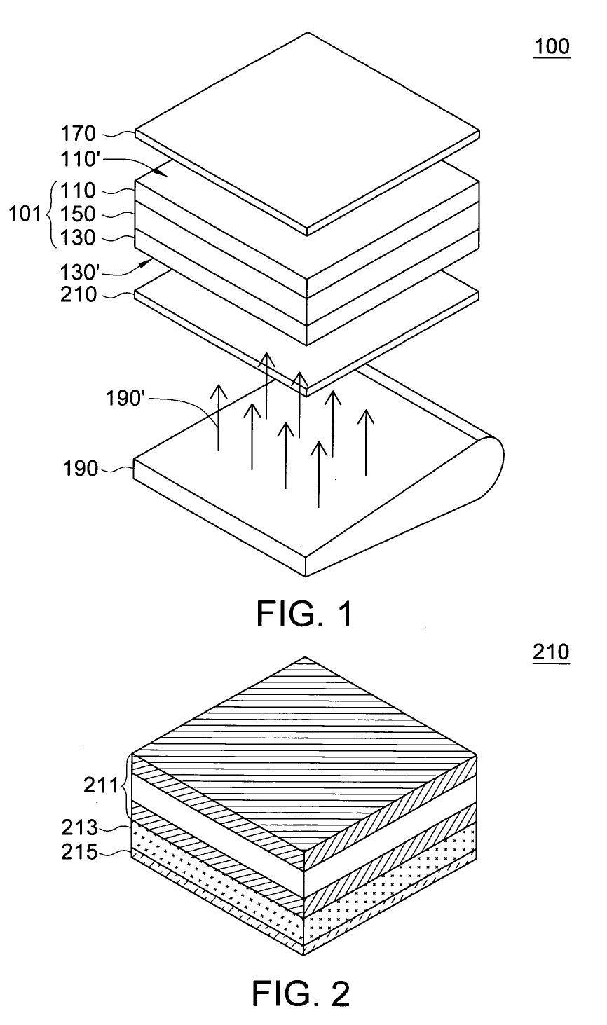

Referring to both FIG. 1 and FIG. 2. FIG. 1 shows a display device according to a preferred embodiment of the invention. FIG. 2 shows a polarizing plate according to a preferred embodiment of the invention. As indicated in FIG. 1, the display device 100 comprises a first substrate 110, a second substrate 130, a liquid crystal layer 150, a first polarizing film 170 and a polarizing plate 210. The second substrate 130 is opposite to the first substrate 110. The liquid crystal layer 150 is contained between the first substrate 110 and the second substrate 130 to form a display panel 101. The first polarizing film 170 is disposed on an outer surface 110′ of the first substrate 110. As indicated in FIG. 2, the polarizing plate 210 comprises a second polarizing film 211, a brightness-enhancement film 213 and a diffuser layer 215, wherein the polarizing plate 210 is disposed on an outer surface 130′ of the second substrate 130 as indicated in FIG. 1. In the present embodiment, the second polarizing film 211 contacts with the outer surface 130′ of second substrate 130. Both the first polarizing film 170 and the second polarizing film 211 comprise a polarizing film and at least two protection films respectively disposed on two opposite surfaces of the polarizing film. In a preferred embodiment, the diffuser layer 215 preferably has anti-glare function or is substantially an anti-glare layer. The diffuser layer 215 preferably has a rough surface or has diffusion particles added therein for increasing the efficiency of the light 190′.

As indicated in FIG. 1, the display device 100 further comprises a backlight module 190 disposed on one side of the display panel 101, wherein the backlight module 190 is opposite to the polarizing plate 210. That is, the polarizing plate 210 is disposed between the backlight module 190 and the second substrate 130. In other words, the display device 100 of FIG. 1 comprises a first polarizing film 170, a first substrate 110, a liquid crystal layer 150, a second substrate 130, a polarizing plate 210 and a backlight module 190 in a top-down order. The polarizing plate 210 comprises a second polarizing film 211, a brightness-enhancement film 213 and a diffuser layer 215. The first substrate 110 and the second substrate 130 of the display device 100 are respectively a color filter substrate and a transistor array substrate for example. The light 190′ provided by the backlight module 190 reaches the first substrate 110 and the first polarizing film 170 by passing through the liquid crystal layer 150 via the polarizing plate 210 and the second substrate 130, wherein the arrangement of the liquid crystal molecules of the liquid crystal layer 150 changes according to the voltage applied to the pixel electrodes of the transistor array substrate such that the polarization direction of the light 190′ passing through the liquid crystal layer 150 is changed accordingly. The polarizing plate 210 of the present embodiment of the invention integrates the commonly known polarizing film 211, the brightness-enhancement film 213 and the diffuser layer 215 into one single optical plate, hence the polarizing plate 210 of the present invention has the additional functions of brightness-enhancement and diffusion. Thus, compared with the conventional backlight module, the backlight module 190 of the present embodiment of the invention only needs one diffusion film or does not need any diffusion film. For example, the conventional backlight module has an upper diffusion film and a lower diffusion film, but the backlight module 190 of the present embodiment of the invention only needs the lower diffusion film (not illustrated in the diagram) and does'nt need the upper diffusion film. Thus, the diffuser layer 215 of the polarizing plate 210 functions as the upper diffusion film and replaces the upper diffusion film. In a preferred embodiment, the thickness of the diffuser layer 215 is substantially smaller than or equal to 50 μm, and preferably substantially ranges from 5 μm to 20 μm. The diffusion film used in the commonly known backlight module must require forming the diffuser layer on a substrate made of polymers such as polycarbonate (PC) or poly ethylene terephthalate (PET), such that the thickness of the commonly known diffusion film is about 200 μm or more. Thus, using the structure of the polarizing plate 210 of the present invention would reduce not only the quantity and thickness of the diffusion film but also the overall thickness of the display device. In the preferred embodiment disclosed above, the overall thickness of the display device 100 is reduced by at least about 150 μm.

Under different levels of optical haze, the brightness and contrast of the display device 100 having a polarizing plate 210 of the preferred embodiment of the invention are tested and compared with that of the structure of a conventional display device (that is, many optical films are disposed in the backlight module). Part of the experimental results are listed in Table 1˜Table 3. In the following experiments, experiments are preformed on a second polarizing film 211 formed by containing a poly vinyl alcohol (PVA) layer 211b of a polarizing film between two triacetyl cellulose (TAC) layers 211a and 211c of a protection film but the invention is not limited thereto.

### Experiment 1

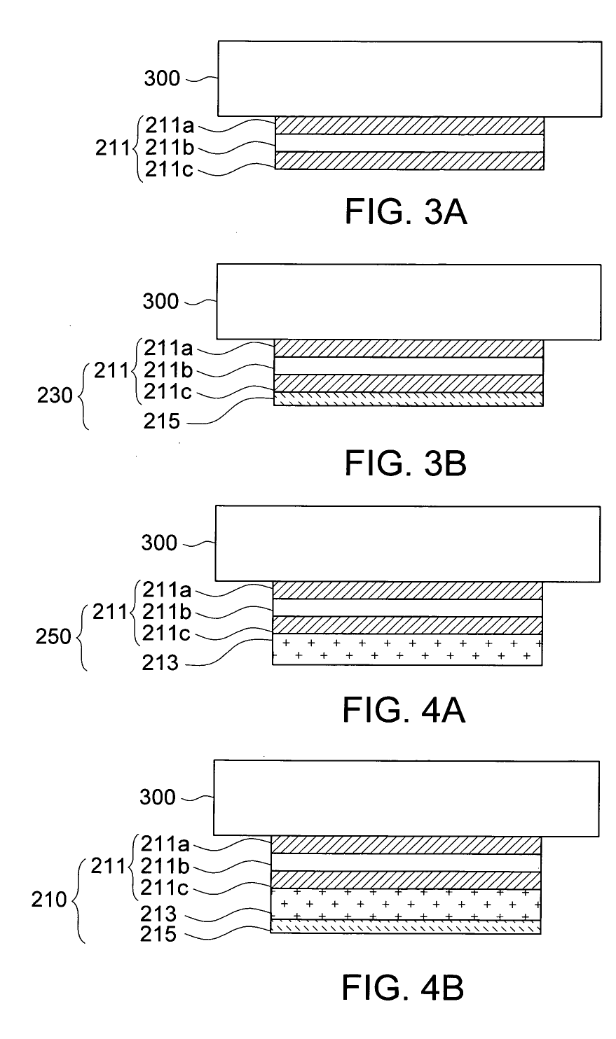

In Experiment 1, brightness and contrast tests of structures of the polarizing plate are conducted. Referring to FIG. 3A and FIG. 3B, the polarizing plates according to a first control experimental group and a first experimental group in Experiment 1 of the invention are respectively shown. Compared with the backlight module of the first control experimental group, the backlight module of the first experimental group uses one less upper diffusion film (not illustrated in the diagram). As indicated in FIG. 3A, the polarizing plate of the first control experimental group is disposed on the display panel 300 and only comprises a second polarizing film 211. As indicated in FIG. 3B, the polarizing plate 230 of the first experimental group adds a diffuser layer 215 having the functions of anti-glare and high diffusion function onto a second polarizing film 211. That is, the difference between the first experimental group and the first control experimental group lies in that the backlight module of the first experimental group has one less upper diffusion film than the backlight module of the first control experimental group, and a diffuser layer 215 is disposed on the second polarizing film 211 of the polarizing plate 230 of the first experimental group. The polarizing plate 230 of the first experimental group is compared with the polarizing plate of the first control experimental group under three levels of optical haze including 60%, 74% and 88%. The experimental results are listed in Table 1.

TABLE 1

| | First Control | | | |
|---|---|---|---|---|
| | Experimental Group | | | |
| | (Second | First Experimental Group | | |
| Properties | Polarizing Film 211) | (Polarizing Plate 230) | | |
| Haze (%) | | 60 | 74 | 88 |
| Brightness of | 125.71 | 132.14 | 91.62 | 70.41 |
| Bright State | | | | |
| Brightness of | 0.27 | 0.3 | 0.25 | 0.23 |
| Dark State | | | | |
| Contrast | 465.59 | 440.47 | 336.48 | 306.13 |
| Increasing Rate | | 5.1 | −27.1 | −44.0 |
| of Brightness | | | | |
| (%) | | | | |
| Increasing Rate | | −5.4 | −21.3 | −34.2 |
| of Contrast (%) | | | | |

According to the experimental results shown in Table 1, when the optical haze is at the level of 60%, the polarizing plate 230 has higher brightness of bright state than the second polarizing film 211 of the first control experimental group. When the optical haze is at the level of 74% and 88%, brightness of the bright state, brightness of the dark state and contrast of the polarizing plate 230 are inferior to that of the second polarizing film 211 of the first control experimental group. The increasing rate of brightness and the increasing rate of contrast in Table 1 are the increase rates determined according to the comparison of brightness of bright state and contrast between the first experimental group and the first control experimental group. As indicated in Table 1, the increasing rate of brightness of the first experimental group is positive 5.1% only when the level of optical haze is 60%, and the brightness and contrast of the first experimental group are inferior to that of the first control experimental group when the level of optical haze is other than 60%. Thus, the optical properties of the polarizing plate 230 with the second polarizing film 211 and the diffuser layer 215 being disposed thereon are inferior to that of the second polarizing film 211 without the diffuser layer 215.

Moreover, referring to FIGS. 4A and 4B, the polarizing plates according to a second control experimental group and a second experimental group in Experiment 1 of the invention are respectively shown. The backlight module of the second experimental group has one less upper diffusion film (not illustrated in the diagram) than the backlight module of the second control experimental group. As indicated in FIG. 4A, the polarizing plate 250 of the second control experimental group comprises a second polarizing film 211 and a brightness-enhancement film 213 disposed on a second polarizing film 211. As indicated in FIG. 4B, the second experimental group of the preferred embodiment of the invention refers to the polarizing plate 210. The polarizing plate 210 comprises a second polarizing film 211 and a brightness-enhancement film 213, and a diffuser layer 215 which is absent in the second control experimental group. That is, the second experimental group differs from the second control experimental group in that the backlight module of the second experimental group has one less upper diffusion film than the backlight module of the second control experimental group, and the second polarizing film 211 of the polarizing plate 230 of the second experimental group has a diffuser layer 215 disposed thereon. The polarizing plate 210 of the second experimental group is compared to the polarizing plate 250 of the second control experimental group while the optical haze of the polarizing plate 210 is respectively at the level of 60% and 74%, and the experimental results are listed in Table 2.

TABLE 2

| | Second Control | | |
|---|---|---|---|
| | Experimental | | |
| | Group | | |
| | (Polarizing Plate | Second Experimental Group | |
| Properties | 250) | (Polarizing Plate 210) | |
| Haze (%) | | 60 | 74 |
| Brightness of Bright | 154.54 | 225.43 | 166.02 |
| State | | | |
| Brightness of Dark | 0.37 | 0.47 | 0.39 |
| State | | | |
| Contrast | 417.68 | 479.64 | 425.69 |
| Increasing Rate of | | 45.9 | 7.4 |
| Brightness (%) | | | |
| Increasing Rate of | | 14.8 | 1.9 |
| Contrast (%) | | | |

According to the experimental results shown in Table 2, when the optical haze is at the level of 60% and 74%, the bright state brightness, dark state brightness and contrast of the polarizing plate 210 are all higher than that of the second control experimental group. When the optical haze is at the levels of 60% and 74%, the optical properties of the polarizing plate 210 including brightness increase rate and contrast increase rate are all superior to that of the second control experimental group.

According to results presented in Table 1 and Table 2, the optical properties of the polarizing plate (such as the polarizing plate 230) with the second polarizing film 211 and a diffuser layer 215 formed thereon are inferior to that of the polarizing plate without a diffuser layer. However, the optical properties of the polarizing plate 210 of the preferred embodiment of the invention which integrates the brightness-enhancement film 213 with the diffuser layer 215 into the second polarizing film 211 are superior to that of other polarizing plates. Thus, the optical properties of the polarizing plate are effectively increased.

### Experiment 2

According to the results of Experiment 1, the optical properties of the polarizing plate are slightly different under different levels of optical haze. Thus, in Experiment 2, the brightness and contrast tests of the polarizing plate 210 with different values of optical haze of the second experimental group are conducted. The polarizing plate 250 (having a brightness-enhancement film 213) of FIG. 4A is used as the control experimental group in this experiment. As disclosed above, the backlight module of the experimental group has one less upper diffusion film (not illustrated in the diagram) than the backlight module of the control experimental group. The experimental results are listed in Table 3.

TABLE 3

| | Control | | | | | |
|---|---|---|---|---|---|---|
| | Experimental | | | | | |
| | Group | | | | | |
| | (Polarizing | Experimental Group | | | | |
| Properties | Plate 250) | (Polarizing Plate 210) | | | | |
| Haze (%) | | 11 | 25 | 40 | 60 | 74 |
| Brightness | 154.54 | 169.03 | 170.19 | 191.62 | 225.43 | 166.02 |
| of Bright | | | | | | |
| State | | | | | | |
| Brightness | 0.37 | 0.39 | 0.4 | 0.43 | 0.47 | 0.39 |
| of Dark | | | | | | |
| State | | | | | | |
| Contrast | 417.68 | 433.41 | 425.48 | 445.63 | 479.64 | 425.69 |
| Increasing | | 9.4 | 10.1 | 24 | 45.9 | 7.4 |
| Rate of | | | | | | |
| Brightness | | | | | | |
| (%) | | | | | | |
| Increasing | | 3.8 | 1.9 | 6.7 | 14.8 | 1.9 |
| Rate of | | | | | | |
| Contrast | | | | | | |
| (%) | | | | | | |

According to the experimental results shown in Table 3, when the level of the optical haze ranges substantially between 10%˜75%, the bright state brightness of the polarizing plate 210 of the present embodiment of the invention is higher than that of the polarizing plate 250. The level of the optical haze of the polarizing plate 210 ranges substantially between 10%˜75%, and preferred optical properties are obtained when the level of the optical haze ranges substantially from 40% to 60%. Furthermore, the overall brightness of the polarizing plate 210 of the present embodiment of the invention is higher than that of the polarizing plate 250 of the control experimental group by about 9%˜46%, and the contrast of the polarizing plate 210 is higher than that of the polarizing plate 250 of the control experimental group by about 2%˜15%. Thus, when the polarizing plate 210 of the present embodiment of the invention is used in the display device 100, the brightness and contrast of the display device 100 will both be increased effectively.

### Method of Manufacturing Polarizing Plate

A method of manufacturing a polarizing plate of a preferred embodiment of the invention is disclosed below. However, the disclosure below is for elaboration only, the detailed procedures can be appropriately changed to fit the practical needs, and other technologies can also be used during manufacturing the polarizing plate of the invention.

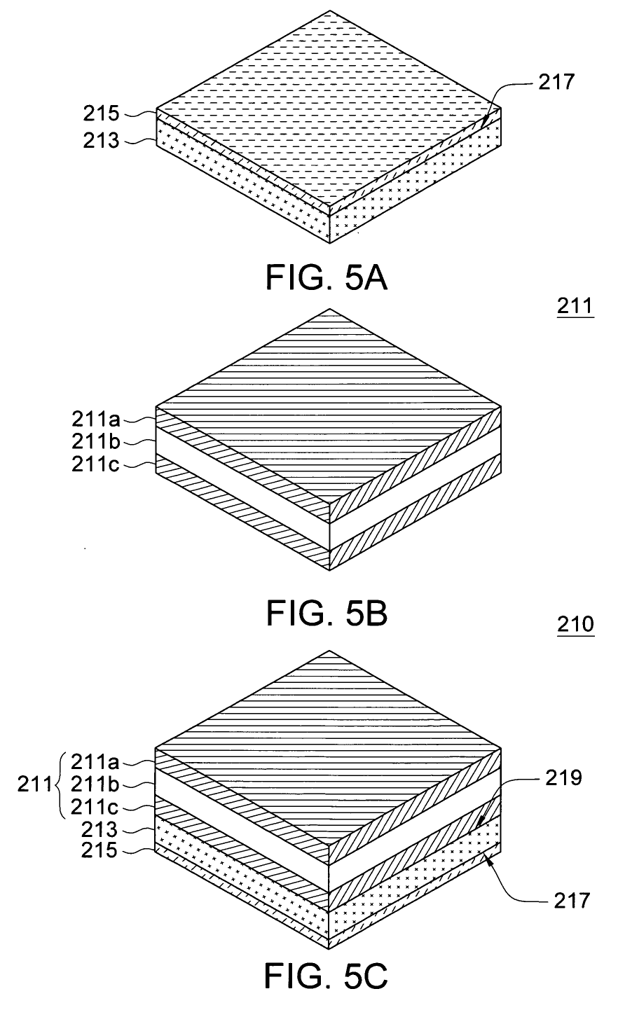

Referring to FIGS. 5A˜5C, a method of manufacturing the polarizing plate of FIG. 2 are sequentially shown.

First, as indicated in FIG. 5A, a brightness-enhancement film 213 is provided. The brightness-enhancement film 213 is for increasing the brightness of the light 190′ (illustrated in FIG. 1). The brightness-enhancement film 213 preferably is a reflective polarizing brightness-enhancement film, such as a dual brightness enhancement film (DBEF) by 3M or an advanced polarization conversion film (APCF) by Nitto Denko. The reflective polarizing brightness-enhancement film is capable of polarizing the reflected light for many times to increase the efficiency of the light 190′.

Next, as indicated in FIG. 5A, a diffuser layer 215 is formed on the brightness-enhancement film 213, wherein the diffuser layer 215 could be formed on one surface 217 of the brightness-enhancement film 213 by wet coating. The diffuser layer 215 preferably has a rough surface or has diffusion particles added therein for uniformly dispersing the light 190′. In a preferred embodiment, the thickness of the diffuser layer 215 is substantially smaller than or equal to about 50 μm. Preferably, the thickness of the diffuser layer 215 ranges substantially from 5 to 20 μm, approximately.

Then, as indicated in FIG. 5B, the second polarizing film 211 of FIG. 2 is provided. The second polarizing film 211 preferably comprises two TAC layers (used as protection films) 211a and 211c, wherein a PVA layer (used as a polarizing film) 211b is disposed between the TAC layers 211a and 211c. The PVA layer 211b is for polarizing the light 190′, and the TAC layers 211a and 211b are for protecting the PVA layer 211b.

Afterwards, as indicated in FIG. 5C, the brightness-enhancement film 213 of FIG. 5A having the diffuser layer 215 and the second polarizing film 211 are integrated into one single plate, that is, a polarizing plate 210. The single plate can be formed by a pasting method. The second polarizing film 211 is formed on another surface 219 of the brightness-enhancement film 213, which the surface 219 is opposite to the surface 217. In a preferred embodiment, an adhesive layer (not illustrated in the diagram) is formed between the second polarizing film 211 and another surface 219 of the brightness-enhancement film 213 for attaching the brightness-enhancement film 213 having the diffuser layer 215 with the second polarizing film 211 to form a polarizing plate 210. Moreover, the polarizing plate 210 of the present embodiment of the invention has an optical haze which is substantially smaller than about 75%. Preferably, when the optical haze of the polarizing plate 210 ranges substantially from about 40% to 60%, the polarizing plate has superior optical properties.

According to the polarizing plate and a manufacturing method thereof, the present embodiment of the invention, the brightness-enhancement film 213 and the diffuser layer 215 are integrated into a single polarizing plate 210. The brightness-enhancement film 213 and the diffuser layer 215 replace the brightness-enhancement film and the diffusion film of a commonly known backlight module. As the thickness of the diffuser layer 215 used in the embodiment of the invention is substantially smaller than about 50 μm, the overall thickness of the display device 100 after assembly is considerably reduced by at least about 150 μm.

The polarizing plate 210 of the embodiment of the invention is used in the display device 100 with the backlight module 190. However, the polarizing plate of the embodiment of the invention used in the trans-reflective liquid crystal display device or the reflective liquid crystal display device in the absence of the backlight module for increasing the brightness and contrast of the display device is still within the scope of protection of the invention.

A polarizing plate, a manufacturing method thereof and a display device using the same are disclosed in the above embodiment of the invention. By integrating the polarizing film, the brightness-enhancement film and the diffuser layer into a single polarizing plate, the brightness and contrast of the display device are largely increased. Furthermore, the present embodiment of the invention integrates the element for changing the path with the element for changing the polarity of the light so as to reduce the quantity of the optical film of the backlight module of the present embodiment of the invention. Compared with the commonly known display devices, the display device of the present embodiment of the invention has smaller volume, lower weight and better optical properties. The invention simplifies the structure and effectively increases the optical properties of the display device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A polarizing plate used in a display device, the polarizing plate comprising:
a brightness-enhancement film;
a diffuser layer formed on one surface of the brightness-enhancement film; and
a polarizing film disposed on another surface of the brightness-enhancement film.

2. The polarizing plate according to claim 1, wherein the diffuser layer is an anti-glare layer.

3. The polarizing plate according to claim 1, wherein the brightness-enhancement film is a reflective polarizing brightness-enhancement film.

4. The polarizing plate according to claim 1, wherein a thickness of the diffuser layer is substantially smaller than or equal to 50 μm.

5. The polarizing plate according to claim 1, wherein a thickness of the diffuser layer substantially ranges from 5 to 20 μm.

6. The polarizing plate according to claim 1, wherein an optical haze of the polarizing plate is substantially smaller than 75%.

7. The polarizing plate according to claim 1, wherein the polarizing film comprises a polarizing film and at least two protection films respectively disposed on opposite surfaces of the polarizing film.

8. The polarizing plate according to claim 1, wherein an optical haze value of the polarizing plate substantially ranges from 40% to 60%.

9. The polarizing plate according to claim 1, further comprises an adhesive layer disposed between the brightness-enhancement film and the polarizing film.

10. A display device, comprising:
the polarizing plate of claim 1;
a display panel comprising a first substrate, a second substrate, and a liquid crystal layer, wherein the liquid crystal layer is contained between the first substrate and the second substrate; and
a backlight module disposed on one side of the display panel, wherein the polarizing plate is disposed between the backlight module and the display panel.

11. A method of manufacturing polarizing plate, comprising:
providing a brightness-enhancement film;
forming a diffuser layer on the brightness-enhancement film;
providing a polarizing film; and
integrating the polarizing film and the brightness-enhancement film having the diffuser layer into one single plate.

12. The manufacturing method according to claim 11, wherein the diffuser layer is an anti-glare layer.

13. The manufacturing method according to claim 11, wherein the brightness-enhancement film is a reflective polarizing brightness-enhancement film.

14. The manufacturing method according to claim 11, wherein the diffuser layer is formed on the brightness-enhancement film by wet coating.

15. The manufacturing method according to claim 11, wherein the single thin plate is formed by pasting.

16. The manufacturing method according to claim 15, wherein the pasting method comprises forming an adhesive layer for attaching the polarizing film with the brightness-enhancement film having the diffuser layer.
